(19) United States
(12) Patent Application Publication
(10) Pub. No.: US 2011/0166754 A1
(43) Pub. Date: Jul. 7, 2011

(54) CRUISE CONTROL SYSTEM WITH IMPROVED FUEL ECONOMY

(75) Inventors: Carol L. Kolk, White Lake, MI (US); Jason Matthew Kolk, White Lake, MI (US)

(73) Assignee: GM GLOBAL TECHNOLOGY OPERATIONS, INC., Detroit, MI (US)

(21) Appl. No.: 12/651,570

(22) Filed: Jan. 4, 2010

(51) Int. Cl. B60W 30/14; B60W 10/06; B60W 10/10; B60W 50/08

(52) U.S. Cl. 701/54; 701/51

(57) ABSTRACT

A cruise control system for a vehicle includes a speed setpoint module that stores a speed setpoint. A speed variance module stores a predetermined speed variance. The predetermined speed variance can be user defined or preset. A shift inhibiting module receives a transmission downshift request, prevents the requested transmission downshift when a vehicle speed is less than a set speed and greater than the set speed minus the predetermined speed variance and allows the requested transmission downshift when the vehicle speed is less than the set speed minus the predetermined speed variance.

### FIELD

The present disclosure relates to cruise control systems for vehicles.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

A vehicle towing a trailer may need to perform a downshift to maintain a set speed when climbing hills while cruise control is engaged. A similar result may occur when the vehicle is not towing a trailer on hills having higher grades. When driving on rolling hills, the transmission of the vehicle may downshift to maintain the set speed and then stay in the downshifted gear for a short period before shifting back to a higher gear. This downshift may be repeated for each crest. In many instances, the vehicle may perform the downshift just before the top of the rolling hill or near the top of the rolling hill.

The downshifts decrease fuel economy and increase engine noise. Some drivers may disable cruise control on rolling hills to prevent the vehicle from downshift frequently. This approach, however, requires the driver to control the accelerator pedal and reduces the effectiveness of the cruise control system.

### SUMMARY

A cruise control system for a vehicle includes a speed setpoint module that stores a speed setpoint. A speed variance module stores a predetermined speed variance. A shift inhibiting module receives a transmission downshift request, prevents the requested transmission downshift when a vehicle speed is less than a set speed and greater than the set speed minus the predetermined speed variance and allows the requested transmission downshift when the vehicle speed is less than the set speed minus the predetermined speed variance.

In other features, a user interface communicates with the speed variance module and enables a user to set the predetermined speed variance.

In other features, the predetermined speed variance is set by a vehicle manufacturer.

A system includes the cruise control system and further includes an engine control module that communicates with the cruise control system and that controls fuel delivery and spark timing. A transmission control module generates the requested transmission downshift.

A cruise control system for a vehicle includes a speed setpoint module that stores a speed setpoint. A shift inhibiting module receives a transmission downshift request, prevents the requested transmission downshift when a vehicle speed is less than a set speed for a period that is less than a predetermined shift inhibit period and allows the requested transmission downshift when the vehicle speed is less than the set speed for a period that is greater than the predetermined shift inhibit period.

In other features, a user interface communicates with the speed variance module and enables a user to set the predetermined shift inhibit period.

In other features, the predetermined shift inhibit period is set by a vehicle manufacturer.

A system includes the cruise control system and further includes an engine control module that communicates with the cruise control system and that controls fuel delivery and spark timing. A transmission control module generates the requested transmission downshift.

In still other features, the systems and methods described above are implemented by a computer program executed by one or more processors. The computer program can reside on a tangible computer readable medium such as but not limited to memory, nonvolatile data storage, and/or other suitable tangible storage mediums.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of a cruise control system for a vehicle according to the present disclosure;

FIG. 2 is a functional block diagram of another cruise control system for a vehicle according to the present disclosure;

FIG. 3 is a functional block diagram of an exemplary implementation of the control module of FIG. 1 according to the present disclosure;

FIG. 4 is a functional block diagram of another exemplary implementation of the control module of FIG. 1 according to the present disclosure;

FIG. 5 illustrates a method for operating the cruise control system according to the present disclosure; and

FIG. 6 illustrates an alternative method for operating the cruise control system according to the present disclosure.

### DETAILED DESCRIPTION

The following description is merely exemplary in nature and is in no way intended to limit the disclosure, its application, or uses. For purposes of clarity, the same reference numbers will be used in the drawings to identify similar elements. As used herein, the phrase at least one of A, B, and C should be construed to mean a logical (A or B or C), using a non-exclusive logical or. It should be understood that steps within a method may be executed in different order without altering the principles of the present disclosure.

As used herein, the term module refers to an Application Specific Integrated Circuit (ASIC), an electronic circuit, a processor (shared, dedicated, or group) and memory that execute one or more software or firmware programs, a combinational logic circuit, and/or other suitable components that provide the described functionality.

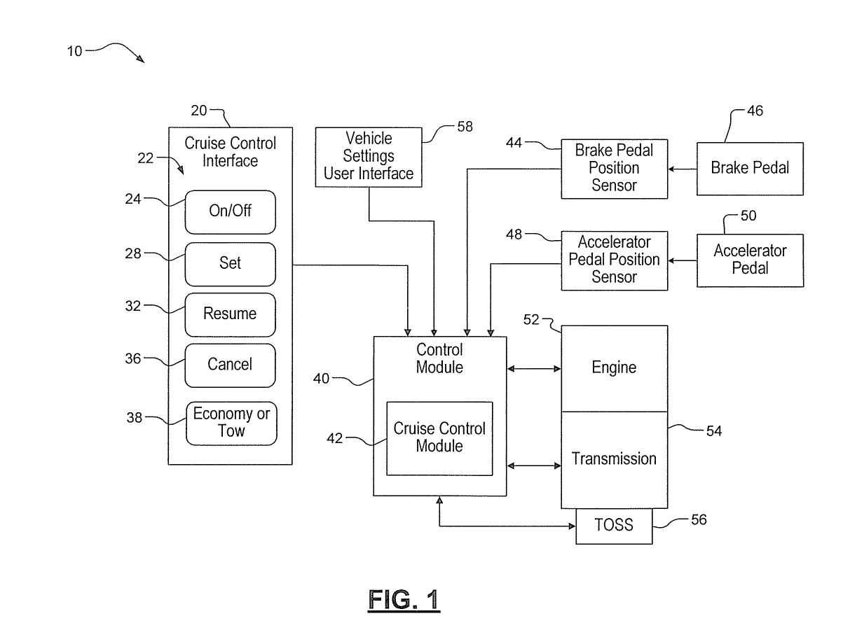

Referring now to FIG. 1, a cruise control system for a vehicle 10 according to the present disclosure is shown. The vehicle 10 includes a cruise control interface 20, which includes input devices 22 that allow a user to control the cruise control system. For example only, the input devices 22 may include an off actuator 24, a set actuator 28, a resume actuator 32, a cancel actuator 36 and/or an economy or tow actuator 38. Some functions of the actuators may be combined. For example only, the on actuator may also operate as the cancel actuator. The actuators may include buttons, switches or other suitable devices.

The cruise control interface 20 communicates with a control module 40 that provides cruise control functions. The control module 40 may comprise a single control module or a group of control modules that communicate. The control module receives user inputs, engine, vehicle and/or transmission speed inputs and transmission control parameters. The control module 40 generates torque requests and/or throttle area requests to maintain vehicle speed, as will be described further below. The control module 40 may generate transmission control signals to inhibit transmission downshifts as needed.

A brake pedal position sensor 44 communicates with the control module 40 and determines a position of a brake pedal 46. In some implementations, the cruise control system is disabled when the brake pedal is depressed by the driver. An accelerator pedal position sensor 48 communicates with the control module 40 and indicates a position of an accelerator pedal 50. The control module 40 communicates with and controls an engine 52 and a transmission 54. For example only, the control module 40 may receive sensed signals such as intake air temperature, mass air flow, throttle position, etc. to allow the control module 40 to control the engine and transmission.

The control module 40 may receive a transmission output speed signal from a transmission output signal sensor (TOSS) 56. Alternately, engine speed at an output of the engine, wheel speed and/or any other suitable approach may be used to monitor vehicle speed.

In some implementations, activating the economy or tow actuator 38 allows the vehicle to decelerate by a predetermined speed variance (such as a predetermined number of miles per hour) before allowing the transmission to downshift. The predetermined speed variance can be fixed by the manufacturer or can be user defined. The predetermined speed variance can be set as distance per unit of time, as a percentage of the set speed and/or using any other suitable approach.

For example only, a user interface 58 may be used to set the predetermined speed variance along with other vehicle settings. Allowing the vehicle to slow without downshifting while the cruise control is engaged will delay noisy and strong downshifts when climbing rolling hills. As a result, the reduced number of downshifts will tend to increase fuel economy.

While the economy or tow actuator 38 is shown in FIG. 1, there are other ways to activate the economy or tow mode of the cruise control system. For example, the economy or tow mode can be activated by a second push of the “on” actuator. Note that the economy or tow mode may be active when towing a trailer on a grade or when climbing hills having higher grades without a trailer.

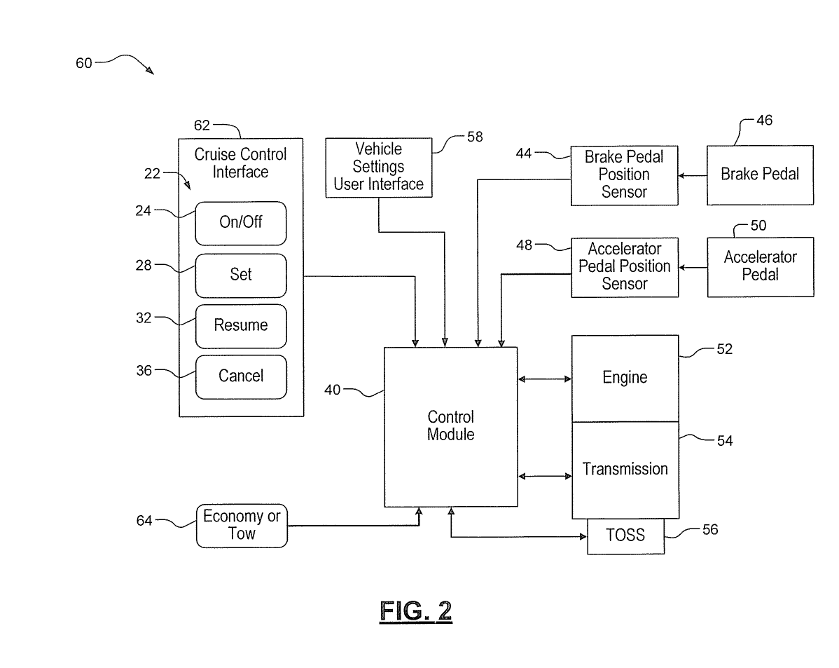

Referring now to FIG. 2, another cruise control system for a vehicle according to the present disclosure is shown. In this implementation, a cruise control interface 62 does not include the economy or tow actuator 38 that is integrated with the cruise control input devices. An actuator 64 that is separate from the cruise control input may be provided. Still other variations are contemplated.

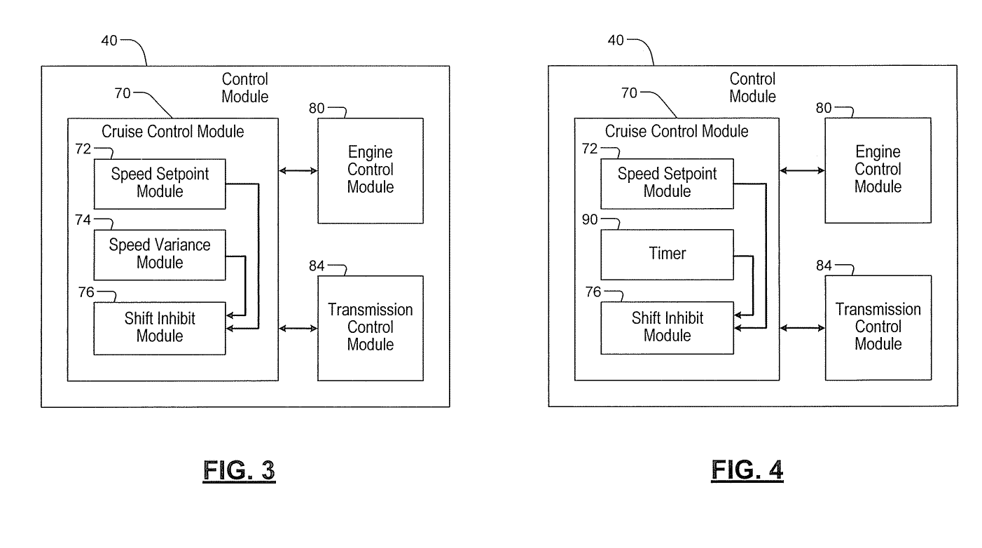

Referring now to FIG. 3, an exemplary implementation of the control module 40 is shown. The control module 40 includes a cruise control module 70 with a speed setpoint module 72, a speed variance module 74 and a shift inhibit module 76.

The control module 40 further includes an engine control module 80 that controls engine operation such as fuel delivery, spark timing and other engine control parameters. The control module 40 may further include a transmission control module 84 that controls operation of a transmission such as timing of shifting of the transmission.

The speed setpoint module 72 stores a speed setpoint that is set by a user. The speed setpoint is the speed that the driver wishes to maintain while the cruise control system is active. A speed variance module 74 stores the predetermined speed variance that may be set by the manufacturer and/or a user. The predetermined speed variance may be a predetermined speed that the vehicle can slow down when a downshift is needed to prevent the downshift. The shift inhibit module 76 compares the speed setpoint, the predetermined speed variance and the current speed.

When a downshift is requested by the transmission control module, the shift inhibit module 76 sends a shift inhibit signal to the transmission control module 84 when the current speed is less than the setpoint speed minus the predetermined speed variance. If the vehicle speed falls below the setpoint speed minus the predetermined speed variance, the shift inhibit signal is disabled and the downshift is allowed to take place.

Referring now to FIG. 4, the cruise control module 70 includes a speed setpoint module 72, a timer 90 and a shift inhibit module 76. The shift inhibit module 76 compares the speed setpoint to the current speed. The timer 90 times a predetermined shift inhibit period starting at a time when the current vehicle speed is less than the speed setpoint and a downshift is requested by the transmission control module.

When the downshift is requested by the transmission control module 84, the shift inhibit module 76 sends a shift inhibit signal to the transmission control module 84 when the current speed is less than the setpoint speed for the predetermined period. When the predetermined period is up, the current vehicle speed is still less than the setpoint speed and the transmission control module is still requesting a downshift, the shift inhibit signal is discontinued and the downshift is allowed to take place.

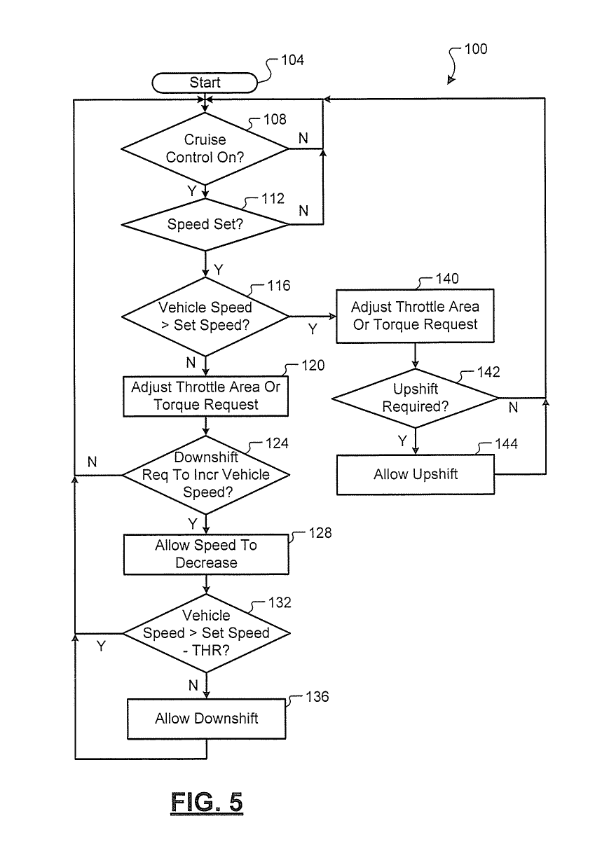

Referring now to FIG. 5, a method 100 for operating the cruise control system according to the present disclosure is shown. Control begins at 104 and proceeds to 108. At 108, control determines whether the cruise control system is on. If 108 is false, control returns to 108. If 108 is true, control determines at 112 whether the user has set a desired speed.

If 112 is false, control returns to 108. If 112 is true, control determines whether the vehicle speed is greater than or equal to the set speed at 116. If 116 is false, control adjusts a throttle area or torque request at 120 to increase the vehicle speed to the set speed. At 124, control determines whether a transmission downshift is required to increase the vehicle speed to the set speed. If 124 is false, control returns to 108. If 124 is true, control allows the vehicle speed to decrease at 128.

At 132, control determines whether the vehicle speed is greater than the set speed minus the predetermined speed variance. If 132 is true, control returns to 108. If 132 is false, control allows the downshift to occur at 136.

If 116 is true, control adjusts the tribal area or torque request to decrease the vehicle speeding to the set speed. At 142, control determines whether a transmission upshift is required. If 142 is false, control returns to 108. If 142 is true, control allows the transmission upshift at 144 and control continues with 108.

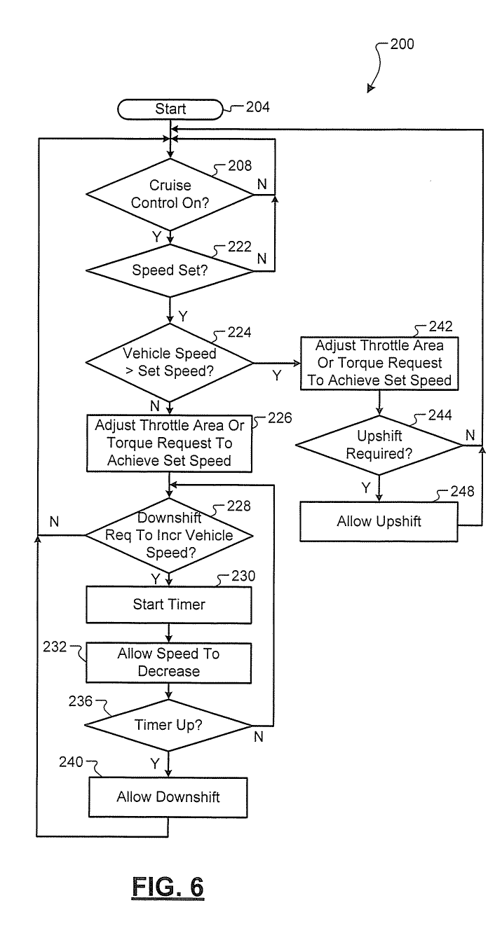

Referring now to FIG. 6, an alternative method 200 for operating the cruise control system according to the present disclosure is shown. Control begins at 204 and proceeds to 208. At 208, control determines whether the cruise control system is on. If 208 is false, control returns to 208. If 208 is true, control determines at 222 whether the user has set a desired speed.

If 222 is false, control returns to 208. If 222 is true, control determines whether the vehicle speed is greater than or equal to the set speed at 226. If 226 is false, control adjusts a throttle area or torque request at 220 to increase the vehicle speed to the set speed. At 224, control determines whether a transmission downshift is required to increase the vehicle speed to the set speed. If 224 is false, control returns to 208. If 224 is true, control starts a timer at 230. At 232, control allows the vehicle speed to decrease. At 236, control determines whether the timer is up. If 236 is false, control returns to 228. If 236 is true, control allows a downshift at 240 and control returns to 208.

If 224 is true, control adjusts the throttle area or torque request to decrease the vehicle speed towards the set speed at 242. At 244, control determines whether a transmission upshift is required. If 244 is false, control returns to 208. If 244 is true, control allows the transmission upshift at 248 and control continues with 208.

In some implementations, the predetermined speed variance is a value between 2 miles per hour and 10 miles per hour. In other implementations, the predetermined speed variance is a value between 4 miles per hour and 7 miles per hour. As can be appreciated, other values may be used.

In some implementations, the predetermined period is a value between 5 seconds and 45 seconds. In other implementations, the predetermined period is a value between 5 seconds and 20 seconds. As can be appreciated, other values may be used.

In still other implementations, a combination of approaches shown in FIGS. 5 and 6 may be used. In other words, the shift can be inhibited for up to the predetermined speed variance and for a period that is less than a predetermined shift inhibit period. Alternately, the shift can be inhibited for a period that is less than the predetermined period as long as the current vehicle speed does not fall below the set speed minus the predetermined speed variance.

The broad teachings of the disclosure can be implemented in a variety of forms. Therefore, while this disclosure includes particular examples, the true scope of the disclosure should not be so limited since other modifications will become apparent to the skilled practitioner upon a study of the drawings, the specification, and the following claims.

What is claimed is:

1. A cruise control system for a vehicle, comprising:
a speed setpoint module that stores a speed setpoint;
a speed variance module that stores a predetermined speed variance; and
a shift inhibiting module that receives a transmission downshift request, that prevents the requested transmission downshift when a vehicle speed is less than a set speed and greater than the set speed minus the predetermined speed variance and that allows the requested transmission downshift when the vehicle speed is less than the set speed minus the predetermined speed variance.

2. The cruise control system of claim 1, further comprising a user interface that communicates with the speed variance module and that enables a user to set the predetermined speed variance.

3. The cruise control system of claim 1, wherein the predetermined speed variance is set by a vehicle manufacturer.

4. A system comprising the cruise control system of claim 1 and further comprising:
an engine control module that communicates with the cruise control system and that controls fuel delivery and spark timing; and
a transmission control module that generates the requested transmission downshift.

5. The cruise control system of claim 1, wherein the shift inhibiting module allows the requested transmission downshift when the vehicle speed is less than the set speed and greater than the set speed minus the predetermined speed variance for a period that is greater than a predetermined shift inhibit period.

6. A cruise control system for a vehicle, comprising:
a speed setpoint module that stores a speed setpoint;
a shift inhibiting module that receives a transmission downshift request, that prevents the requested transmission downshift when a vehicle speed is less than a set speed for a period that is less than a predetermined shift inhibit period and that allows the requested transmission downshift when the vehicle speed is less than the set speed for a period that is greater than the predetermined shift inhibit period.

7. The cruise control system of claim 6, further comprising a user interface that communicates with the speed variance module and that enables a user to set the predetermined shift inhibit period.

8. The cruise control system of claim 6, wherein the predetermined shift inhibit period is set by a vehicle manufacturer.

9. A system comprising the cruise control system of claim 5 and further comprising:
an engine control module that communicates with the cruise control system and that controls fuel delivery and spark timing; and
a transmission control module that generates the requested transmission downshift.

10. The cruise control system of claim 6, wherein the shift inhibit module allows the requested transmission downshift when the vehicle speed is less than the set speed minus a predetermined speed variance.

11. A method for operating a cruise control system for a vehicle, comprising:
storing a speed setpoint;
storing a predetermined speed variance;
receiving a transmission downshift request;
preventing the requested transmission downshift when a vehicle speed is less than a set speed and greater than the set speed minus the predetermined speed variance; and
allowing the requested transmission downshift when the vehicle speed is less than the set speed minus the predetermined speed.

12. The method of claim 11, further comprising providing an interface to allow a user to set the predetermined speed variance.

13. The method of claim 11, wherein the predetermined speed variance is set by a vehicle manufacturer.

14. The method of claim 11, further comprising allowing the requested transmission downshift when the vehicle speed is less than the set speed and greater than the set speed minus the predetermined speed variance for a period that is greater than a predetermined shift inhibit period.

15. A method for operating a cruise control system for a vehicle, comprising:
storing a speed setpoint;
receiving a transmission downshift request;
preventing the requested transmission downshift when a vehicle speed is less than a set speed for a period that is less than a predetermined shift inhibit period; and
allowing the requested transmission downshift when the vehicle speed is less than the set speed for a period that is greater than the predetermined shift inhibit period.

16. The method of claim 15, further comprising providing an interface to allow a user to set the predetermined shift inhibit period.

17. The method of claim 15, wherein the predetermined shift inhibit period is set by a vehicle manufacturer.

18. The method of claim 15, further comprising allowing the requested transmission downshift when the vehicle speed is less than the set speed minus a predetermined speed variance.
